(19) United States
(12) Patent Application Publication
(10) Pub. No.: US 2008/0167987 A1
(43) Pub. Date: Jul. 10, 2008

(54) METHOD OF ADMINISTERING AN ANNUITY HAVING PAYMENTS THAT MAINTAIN OR INCREASE IN PURCHASING POWER

(76) Inventor: Paul Otto Pflieger, Woodbury, MN (US)

Correspondence Address: MERCHANT & GOULD PC, P.O. BOX 2903, MINNEAPOLIS, MN, 55402-0903, US

(21) Appl. No.: 11/620,762

(22) Filed: Jan. 8, 2007

(51) Int. Cl. G06Q 40/00; G06F 17/10

(52) U.S. Cl. 705/39

(57) ABSTRACT

A method of administering a single premium immediate annuity is disclosed. The method includes specifying an income payment amount representing a base level of purchasing power each scheduled annuity payment shall be able to substantially achieve. The amount of the annuity payment to be made at scheduled intervals being adjusted to maintain the purchasing power of the annuity payment, whereby the annuity payment is adjusted to accommodate inflation and maintain a base level of purchasing power. The method of administering the annuity including the inclusion of income payment adjustment ceilings and floors, whereby income payments cannot be reduced below a predefined minimum level, nor can income payments increase above a predefined maximum level in any given year.

### FIELD OF INVENTION

The present invention relates to annuities. More specifically, the present invention relates to an annuity product that provides an annuitant income payments that increase in order to substantially maintain income payment purchasing power and never decrease below any previously set income payment level.

### BACKGROUND OF THE INVENTION

Over the next twenty-five years, baby boomers will be retiring in record numbers. Providing for a financially secure retirement will be the next societal imperative. An integral part of a retirement income strategy is the ability to lock-in a guaranteed income. One product that has become a more attractive option for retirees in this regard is the annuity. An annuity is a tax-deferred savings instrument sold and provided by insurance providers. Generally, when an annuity is purchased, its earnings are tax-deferred until the annuitant begins distributions.

Generally fixed rate annuities guarantee a specific interest rate for the life of the annuity, which provides more stability than a variable annuity. Variable annuities invest funds in stocks, bonds, money market accounts or some combination thereof, depending upon the level of risk and return desired by the annuitant. The actual return on variable rate annuities fluctuate with the ups and downs of a financial market (e.g. the stock market, U.S. Treasury Certificates, etc.). Accordingly, an investment in a variable annuity may be worth more or less than the original amount invested.

When people speak of interest rates and annuities they are implying that the annuitant will make payments (i.e. annuity premiums) over an amount of time (e.g. ten years, twenty years, etc.) and during that time the monies paid generate a return, either fixed or variable. Upon reaching retirement age, the annuitant may decide to annuitize the contract. For example, the annuitant may pay monthly annuity premiums for ten years and the premiums may earn an interest rate of 4% per annum.

The problem with fixed annuity products is that in some years, the fixed rate of return may not keep place with inflation. When the fixed rate of return is less than inflation, the purchasing power of the payment provided by the fixed rate annuity declines. On the other hand annuities that are linked to inflation may have payments that decrease in deflationary environments. A reduction in payments could be problematic for some annuitants.

### BRIEF SUMMARY OF THE INVENTION

Consistent with embodiments of the present invention a method of administering a single premium immediate annuity is disclosed. The method includes specifying a payment amount equal to at least the first income payment to be made. The income payment amount represents a base level of purchasing power each scheduled annuity payment shall be able to achieve. The amount of the annuity payment to be made at scheduled intervals being adjusted to maintain the purchasing power of the annuity payment, whereby the annuity payment is adjusted to accommodate inflation and maintain purchasing power. The method of administering the annuity including the inclusion of income payment adjustment ceilings and floors, whereby income payments cannot be reduced below a predefined minimum level, nor can income payments increase above a predefined maximum level in any given year. If in any year an increase would rise above a predefined maximum level, the level of increase shall be limited to the predefined maximum level.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1 depicts stages for executing an annuity having payments of substantially fixed purchasing power;

FIG. 2 depicts income payments based on actual data;

FIG. 3 depicts the total payments received by an annuitant based on actual data;

FIG. 4 depicts income payments based on hypothetical data for a shortened time interval.

### GENERAL DESCRIPTION

Various embodiments are described more fully below with reference to the accompanying drawings, which form a part hereof, and which show specific embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Accordingly, the following detailed description is, therefore, not to be taken in a limiting sense.

Embodiments of the present invention provide a single premium immediate annuity (SPIA). The single premium immediate annuity is of the type that provides an annuitant with income payments that vary, whereby the income payments may only be adjusted upward and shall substantially maintain a previously defined level of purchasing power.

At the onset of the annuity, the annuitant may pay a single premium and may immediately begin receiving income payments. The income payments may be paid in monthly, quarterly, semi-annual, or annual installments. The income payments are adjusted at time intervals as specified in the annuity contract. The adjustments may be calculated using a Consumer Price Index (CPI). Using the CPI as a metrics helps to ensure that the purchasing power of the income payment remains relatively constant over time.

During administering the annuity income payments, the income payment adjustments may not exceed a maximum level previously defined. In one embodiment, the adjustments to income payments may not exceed a previously defined percentage level of the current income payment. It is also contemplated that in another embodiment, the maximum adjustment level may be a predefined amount or amounts, as an alternative to a previously defined percentage level of the embodiment described herein. Setting a maximum adjustment percentage level assists the annuity issuer with controlling costs associated with the risks of payment increases that occur during periods of excessively high inflation. In addition, income payment adjustments shall only be upward. For example, during a given year if inflation is 15% and the annuity contract specifies a maximum income payment adjustment of 10%, then the income payment shall only be increased 10%. If in the following year inflation is −2%, the income payment will not be decreased. If in the following year inflation is −3%, the income payment will not be decreased and will remain at its current level. During periods of negative inflation, the income payment adjustment is set to 0% and the income payment would therefore remain constant. The effect of the present method of administering an annuity product configured to include income payment adjustment ceilings and floors is to shift the consumer risks during a negative inflationary period from the customer to the insurance company. Accordingly, the present invention does not adjust payments downward, even after increases from a previous year. All increases in payment levels shall remain following adjustment. Another effect of the present method of administering an annuity product configured to include income payment adjustment ceilings and floors is to shift a portion of the insurance company risks during excessive inflationary periods from the issuer of the annuity to the annuitant by capping the level of increase in any given year.

The Consumer Price Index (CPI) is a statistical time-series measure of a weighted average of prices of a specified set of goods and services purchased by consumers. It is a price index that tracks the prices of a specified basket of consumer goods and services, providing a measure of inflation. It is to be understood that Consumer Price Index values used in accordance with the present invention include at least the consumer price index values reported by the U.S. Bureau of Labor Statistics and any other statistical time-series measure of a weighted average of prices, including but not limited to, the Consumer Price Index for all Urban Consumers (CPI-U).

### DETAILED DESCRIPTION

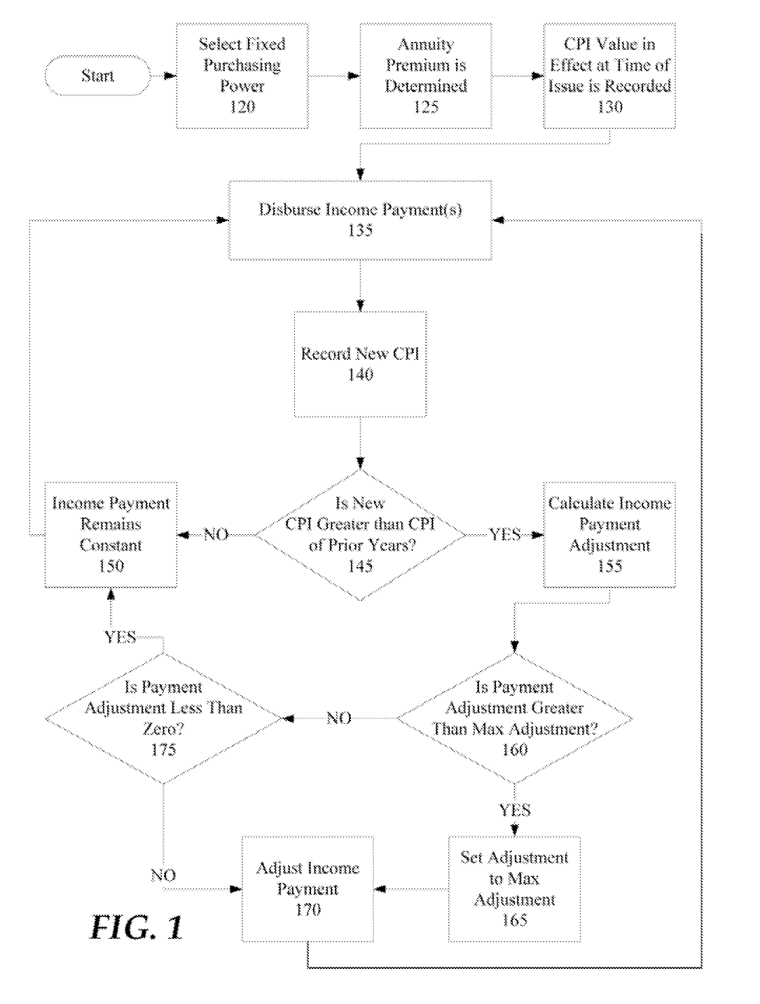

Referring more particularly to the drawings, FIG. 1 depicts stages for administering an annuity having income payment characteristics, including income payment adjustment ceilings and floors, which modify annuitant and annuity issuer risks. The annuitant first elects to lock-in fixed purchasing power 120. Next, the method shown in FIG. 1 illustrates the determination of an annuity premium 125, which is a function of many factors. By way of example and not limitation it is contemplated that factors used to determine the annuity premium may include income payment amount, a maximum income payment adjustment permitted, restriction allowing only payment adjustments upward, length of time/number of income payments between adjustments of income payment, projected life span of annuitant, length of time income payments may be provided, and survival benefits. For example, an annuity with an initial income payment of $1,000.00 per month with a maximum income payment adjustment of 10% per annum may have a higher premium than an annuity with an initial income payment of $500.00 per month with a maximum income payment adjustment of 5% per annum. As another example, an annuity where the annuitant has a remaining life expectancy of 40 years may have a higher premium than an annuity where the annuitant has a remaining life expectancy of 10 years. The possible permutation of factors and resulting premium is virtually limitless.

Once the annuity premium has been determined, a CPI value is recorded 130. The recorded CPI value may be the CPI value in effect at a time prior to entering the annuity contract. For example, the CPI value in effect at the time the annuity contract is executed may be the CPI value three months prior to execution of the annuity contract. For example, if the annuity contract is executed in March, then the CPI value recorded may be the CPI value for January. After the annuity premium has been determined and paid 125 and the initial CPI recorded 130, the income payments may be disbursed 135.

At the end of the disbursement period a new CPI value is recorded 140. Once the new CPI value is recorded 140, a determination needs to be made as to whether the new CPI value is greater than the current CPI value 145. If the new CPI value is less than the current CPI value the income payments may remain constant 150 and the income payments are disbursed 135.

If the new CPI value is greater than the current CPI value, then an income payment adjustment may be calculated 155. The income payment adjustment may be calculated as a ratio of the new CPI value to the current CPI value. Consistent with embodiments of the invention, the income payment adjustment may be determined in accordance with the following formula:

$$Income Payment Adjustment = ( \frac{{CPI}_{t}}{{CPI}_{t - 1}} - 1 ) 100 \% \qquad ( Equation 1 )$$

where:
CPIₜ=the new CPI value;
CPIₜ₋=the current CPI value.

By way of example, if the initial CPI is 31.7 and the new CPI is 32.9, then the income payment adjustment would be 3.79%. Just as with the fixed percentage income payment, adjustment of the income payments may occur at time intervals as specified by the annuity contract. It is to be understood that the time period may be monthly, quarterly, semi-annually, annually, or any other defined time period. For example, the yearly sum of income payments may increase by the income payment adjustment. In other words, if the yearly income payment total is $12,000.00 for a first time period and the income payment adjustment is 3.79 %, then the second yearly income payment would be 12,454.25.

Once the income payment adjustment is calculated 155, it may be compared to a maximum income payment adjustment 160. The maximum income payment adjust may be specified in the annuity contract and may be used to help shield an annuity provider against excessive income payment increases. If the income payment adjustment rate is greater than the maximum income payment adjustment, then the income payment adjustment rate is set to the maximum income payment adjustment 165 and income payments may be adjusted 170 and income payments disbursed 135. For example, the annuity contract may specify a maximum income payment adjustment of 10% and if the inflation rate is greater than 10%, the income payment adjustment is set to 10%. By way of example, during 1979 and 1980, the United States experienced inflation rates of 12.07% and 12.77%, respectively. An annuity contract in effect during those years that specified a maximum income payment adjustment of 10% would have the income payment adjustments set to 10%. In other words, if the income payment in 1979 was $1,000.00 the income payment for 1980 would be $1,100.00 (10% adjustment) instead of $1,120.70 (12.07% adjustment).

If the income payment adjustment is less than the maximum income payment adjustment 160, then the income payment adjustment will be checked to ensure it is greater than zero. The annuity product of the present invention includes a deflation floor component which prevents an annuitant's income payments from decreasing during times of deflation. During a period of negative inflation, an annuitant's income adjustment is set to zero and the income payment remains constant 150. Income payment gains from prior years are not stepped down in response to deflation, the income payments remain constant until the CPI index value exceeds the CPI index value which generated the current income payment. For example, if the income payment is $1,000.00 and negative inflation suggests an income payment adjustment of −2.56%, then the income payment adjustment is set to 0% and the income payment remains $1,000.00.

When the income payment adjustment is between zero and the maximum income payment adjustment, the income payment is adjusted by the income payment adjustment 175 and disbursed 135. For example, if the income payment is $1,000.00, the income payment adjustment is 4.38%, and the maximum income payment adjustment is 10%, then the income payment adjustment is 4.38% and the adjusted income payment is $1,043.80.

Table 1 shows income payment data for actual CPI data collected from 1965 to 2005 and hypothetical income payment.

TABLE 1

| | | | Percent | |
|---|---|---|---|---|
| | Annuity | | Change | |
| | Term | CPI | in CPI | Income |
| Year | Year | Value | Value | payment |
| 1965 | 0 | 31.7 | | $1,000.00 |
| 1966 | 1 | 32.9 | 3.79% | $1,037.85 |
| 1967 | 2 | 33.7 | 2.43% | $1,063.09 |
| 1968 | 3 | 35.3 | 4.75% | $1,113.56 |
| 1969 | 4 | 37.3 | 5.67% | $1,176.66 |
| 1970 | 5 | 39.4 | 5.63% | $1,242.90 |
| 1971 | 6 | 40.9 | 3.81% | $1,290.22 |
| 1972 | 7 | 42.3 | 3.42% | $1,334.38 |
| 1973 | 8 | 45.6 | 7.80% | $1,438.49 |
| 1974 | 9 | 51.1 | 12.06% | $1,611.99 |
| 1975 | 10 | 54.9 | 7.44% | $1,731.86 |
| 1976 | 11 | 57.9 | 5.46% | $1,626.50 |
| 1977 | 12 | 61.6 | 6.39% | $1,943.22 |
| 1978 | 13 | 67.1 | 8.93% | $2,116.72 |
| 1979 | 14 | 75.2 | 12.07% | $2,372.24 |
| 1980 | 15 | 84.8 | 12.77% | $2,675.08 |
| 1981 | 16 | 93.4 | 10.14% | $2,946.37 |
| 1982 | 17 | 98.2 | 5.14% | $3,097.79 |
| 1983 | 18 | 101.0 | 2.85% | $3,186.12 |
| 1984 | 19 | 105.3 | 4.26% | $3,321.77 |
| 1985 | 20 | 108.7 | 3.23% | $3,429.02 |
| 1986 | 21 | 110.3 | 1.47% | $3,479.50 |
| 1987 | 22 | 115.3 | 4.53% | $3,637.22 |
| 1988 | 23 | 120.2 | 4.25% | $3,791.80 |
| 1989 | 24 | 125.6 | 4.49% | $3,962.15 |
| 1990 | 25 | 133.5 | 6.29% | $4,211.36 |
| 1991 | 26 | 137.4 | 2.92% | $4,334.38 |
| 1992 | 27 | 141.8 | 3.20% | $4,473.19 |
| 1993 | 28 | 145.7 | 2.75% | $4,596.21 |
| 1994 | 29 | 149.5 | 2.61% | $4,716.09 |
| 1995 | 30 | 153.7 | 2.81% | $4,848.58 |
| 1996 | 31 | 158.3 | 2.99% | $4,993.69 |
| 1997 | 32 | 161.6 | 2.08% | $5,097.79 |
| 1998 | 33 | 164.0 | 1.49% | $5,173.50 |
| 1999 | 34 | 168.2 | 2.56% | $5,305.99 |
| 2000 | 35 | 174.0 | 3.45% | $5,488.96 |
| 2001 | 36 | 177.7 | 2.13% | $5,605.68 |
| 2002 | 37 | 181.3 | 2.03% | $5,719.24 |
| 2003 | 38 | 185.0 | 2.04% | $5,835.96 |
| 2004 | 39 | 190.9 | 3.19% | $6,022.08 |
| 2005 | 40 | 199.2 | 4.35% | $6,283.91 |

As an example, suppose three individuals each purchased an annuity in 1965 for a term of 40 years. Person one purchased an annuity having fixed purchasing power of $1,000.00, whereby the purchasing power is linked to the CPI Index and the income payments, shown in Table 1, were adjusted by the following formula:

$$Adjusted Income Payment = ( First Income Payment ) ( \frac{{CPI}_{t}}{{CPI}_{t - 1}} )$$

where:
CPIₜ=New CPI value; and
CPIₜ₋₁=Current CPI value.

Person Two purchased an annuity having a fixed percentage increase of 4% and an initial income payment of $1,000.00. Person Three purchased a traditional annuity having a fixed income payment of $1,500.00.

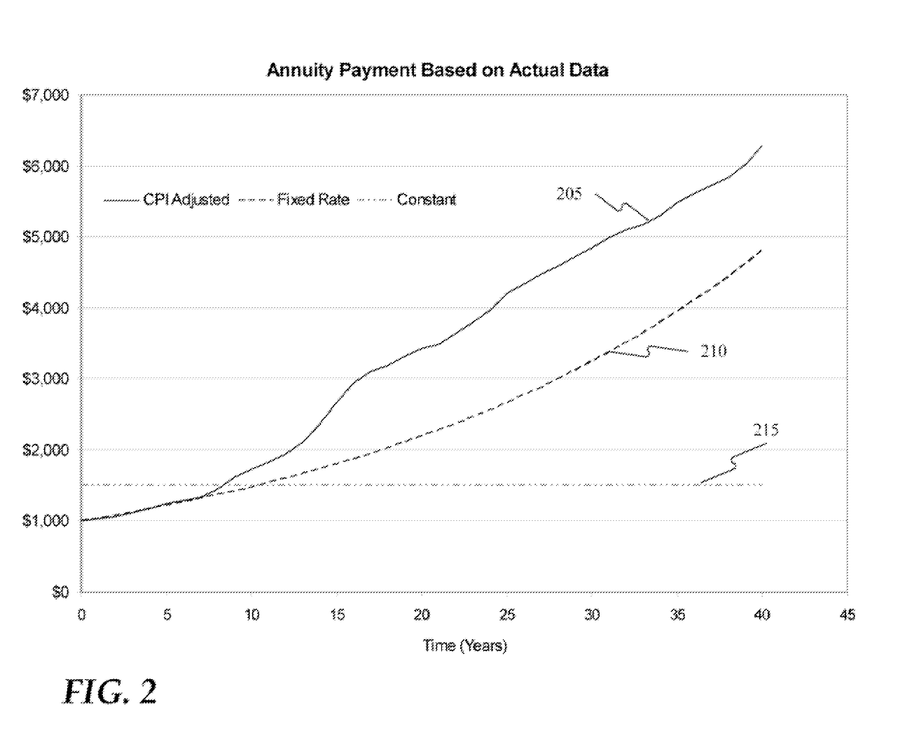

A FIG. 2 is an illustration of the income payments for Person One, Two and Three over a 40 year period. FIG. 2 represents a graphical illustration of the long term effects and variance of income payments across the three different types of annuity income payments. Person One's income payments are linked to the CPI and vary in accordance with the changes in the CPI from year to year. As reference numeral 205 illustrates, Person One has income payments that fluctuate with time and have no regularity. Person Two's income payments are linked to a fixed percentage and increase annually in accordance with the percentage. As indicated by reference numeral 210, Person Two's income payments increase at a regular rate. Person Three's income payments are static. As indicated by reference numerals 215, the income payments of Person Three remain constant over the entire 40 year period. In the short term, between zero to seven years, Person Two and Person One have income payments that closely match, ranging between $1000 and $1,400 over the first seven years of the forty year period. Person Three on the other hand, which has income payments of $1500 over the life of the annuity has larger income payments and greater purchasing power than both Person One and Person Two during the first seven years of the life of the annuity. However, towards the later years of the forty year period, Person Three looses purchasing power. At the end of the 40 year term, Person Three still receives an income payment of $1,500.00 while Person One receives approximately $6,300.00 and Person Two receives approximately $4,800.00. Person One's income payment has about 4.2 times the purchasing power of Person Three's income payment and Person Two's income payment has about 3.2 times the purchasing power of Person Three's income payment.

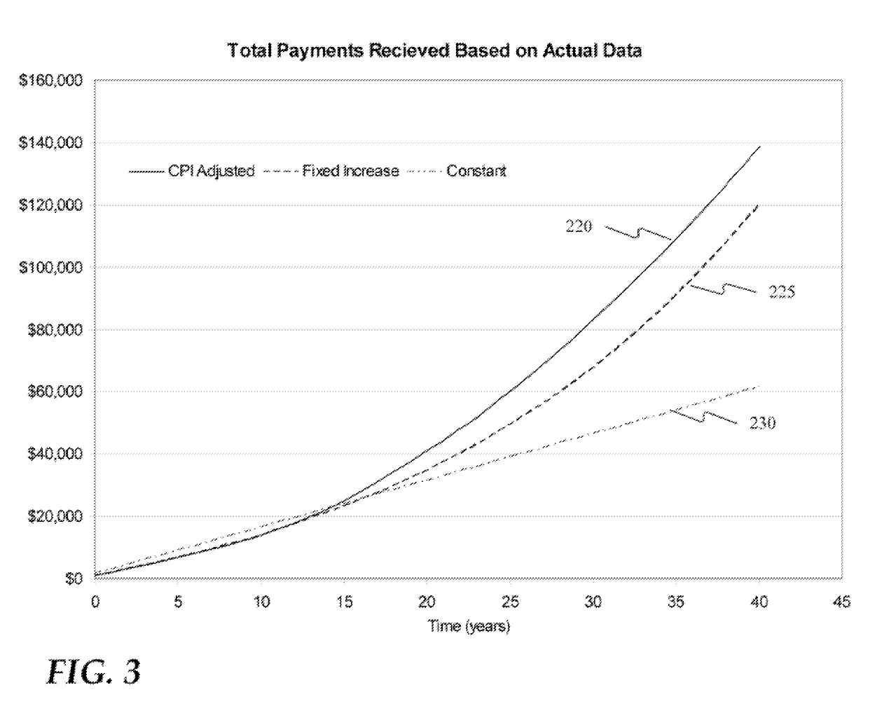

FIG. 3 illustrates the total accumulation of annual income payments received by Person One, Person Two, and Person Three over time, as indicated by reference numerals 220, 225, and 230. Over the course of the 40 year term, Person Three 230 receives an accumulated total of about $60,000.00 in annual income payments. Person Two 225 receives an accumulated total of about $120,000.00 in annual income payments. Person Three 220 receives an accumulated total of about $140,000.00 in annual income payments.

Consistent with embodiments of the invention, during periods in which the CPI decreases, income payments shall not decrease. Accordingly, during deflationary periods, the annuitant gains purchasing power and the new CPI value (which is lower than the current CPI value) does not replace the current CPI value. When a new CPI value is less than a current CPI value, the current CPI value is the CPI floor below which the income payment CPI value may never fall below. In addition, future income payments may not be increased until a new CPI value exceeds the income payment CPI value (i.e., the income payment floor is cumulative).

As an example, suppose an individual purchases an annuity in September of a given year, where the annuity has a term of 20 years, an initial purchasing power of $1,000.00, and a maximum income payment adjustment of 10%. The income payments, shown in Table 2, may be calculated by the following Equations:

If the payment adjustment, as calculated by Equation 1, is less than or equal to 0%:

Adjusted Annuity Payment=Current Income Payment (Equation 2)

If the payment adjustment, as calculated by Equation 1, is greater than 0% and less than or equal to the maximum payment adjustment (10%):

$$Adjusted Annuity Payment = \begin{matrix}( Current Income Payment ) \\ ( \frac{{CPI}_{t}}{{CPI}_{t - 1}} )\end{matrix} \\ \qquad ( Equation 3 )$$

If the payment adjustment, as calculated by Equation 1, is greater than the maximum payment adjustment (10%):

below to

Adjusted Annuity Payment=Current Income Payment×1.10

Adjusted Annuity Payment=(Current Income Payment)+(10%) (Equation 4)

where:
CPIₜ=New CPI value; and
CPIₜ₋₁=Current CPI value.

TABLE 2

| | New | Current | Percent Change | Percent Change | Income | Percent Change |
|---|---|---|---|---|---|---|
| Year | CPI Value | CPI Value | from Previous Year | from Last Adj | Payment | in Income Payment |
| 0 | 31.7 | 31.7 | | | $1,000.00 | |
| 1 | 32.9 | 32.9 | 3.79% | 3.79% | $1,037.85 | 3.79% |
| 2 | 33.7 | 33.7 | 2.43% | 2.43% | $1,063.09 | 2.43% |
| 3 | 33.5 | 33.7 | −0.59% | −0.59% | $1,063.09 | 0.00% |
| 4 | 31.2 | 33.7 | −6.87% | −7.42% | $1,063.09 | 0.00% |
| 5 | 33.0 | 33.7 | 5.77% | −2.08% | $1,063.09 | 0.00% |
| 6 | 34.7 | 34.7 | 5.15% | 2.97% | $1,094.64 | 2.97% |
| 7 | 35.9 | 35.9 | 3.46% | 3.46% | $1,132.49 | 3.46% |
| 8 | 34.3 | 35.9 | −4.46% | −4.46% | $1,132.49 | 0.00% |
| 9 | 40.0 | 40.0 | 16.62% | 11.42% | $1,245.74 | 10.00% |
| 10 | 42.3 | 42.3 | 5.75% | 5.75% | $1,317.37 | 5.75% |
| 11 | 44.2 | 44.2 | 4.49% | 4.49% | $1,376.54 | 4.49% |
| 12 | 45.0 | 45.0 | 1.81% | 1.81% | $1,401.46 | 1.81% |
| 13 | 44.8 | 45.0 | −0.44% | −0.44% | $1,401.46 | 0.00% |
| 14 | 42.3 | 45.0 | −5.58% | −6.00% | $1,401.46 | 0.00% |
| 15 | 45.8 | 45.8 | 8.27% | 1.78% | $1,426.37 | 1.78% |
| 16 | 49.2 | 49.2 | 7.42% | 7.42% | $1,532.26 | 7.42% |
| 17 | 50.6 | 50.6 | 2.85% | 2.85% | $1,575.86 | 2.85% |
| 18 | 55.7 | 55.7 | 10.08% | 10.08% | $1,733.45 | 10.00% |
| 19 | 59.1 | 59.1 | 6.10% | 6.10% | $1,839.26 | 6.10% |
| 20 | 60.9 | 60.9 | 3.05% | 3.05% | $1,895.28 | 3.05% |

At inception of the annuity, during year zero, the CPI value was 31.7. At the start of year 1, the CPI value was 32.9. Therefore from year 0 to year 1 inflation was 3.79% and the income payment increased by 3.79% from $1,000.00 to $1.037.85.bty

There was a deflationary period from year 3 through year 5. Because the income payment floor is cumulative, the current CPI value (for years three through five) is the CPI value for year 2 (i.e. 33.7). In other words, in year 4, the new CPI value was 31.2, which was less than the current CPI value of 33.7; therefore the new CPI value does not become the current CPI value.

In year 6 the CPI value increased to 34.7. Since the new CPI value (34.7) is greater than the current CPI value (33.7) the income payment is adjusted according to Equation 3. In the present example there is a maximum income payment adjustment (ceiling) of 10%. Therefore, in year 9, when the inflation rate from year 8 to year 9 was 16.62%, the income payment only increased 10% as indicated by Equation 4 which was used to calculate the new income payment. Consistent with embodiments of the present invention, in years where the adjustment exceed the maximum adjustment, the excess may or may not be recovered. As shown by the data in Table 2, the excess is not recovered. For example, in year 9 when inflation from year 8 to year 9 was 16.62% the income payment adjustment was capped at 10%. In year 10 when inflation from year 9 to year 10 was 5.75% the income payment was increased 5.75%.

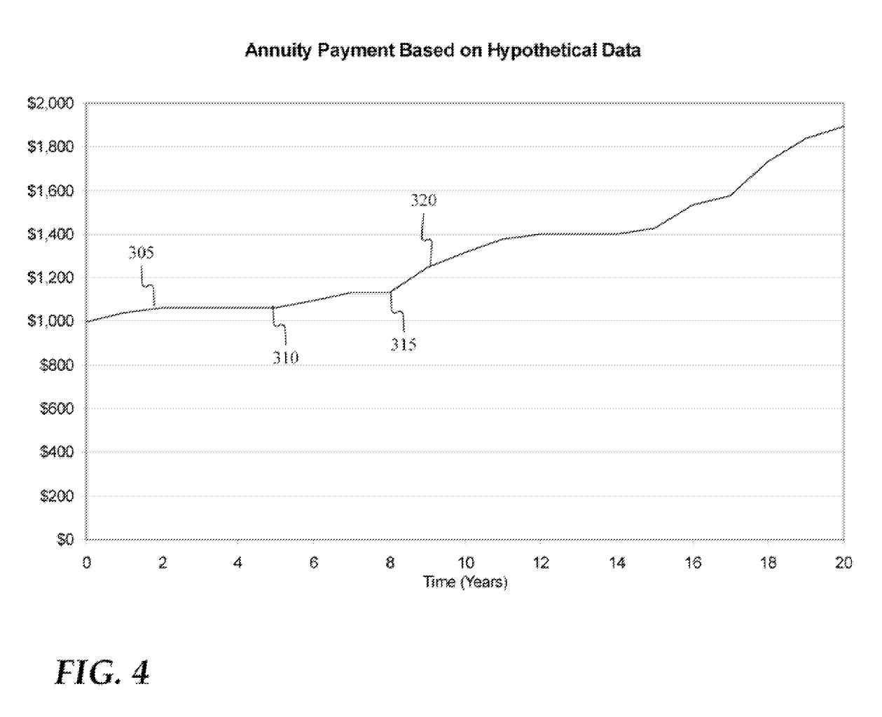

FIG. 4 depicts the income payments shown in Table 2. The graph indicates the rise in income payments from inception year through year 2. At year 2 the graph levels off as indicated by reference number 305 when there is a deflationary period. Reference numeral 310 indicates when the new CPI value has increased beyond the current CPI value from year 2. From year 8 (reference numeral 315) to year 9 (reference numeral 320) there is a period of inflation which exceeds the maximum income payment adjustment of 10% and the graph maximum increase (i.e. slope of the curve) that can be experienced during the life of the annuity contract.

Reference may have been made throughout this specification to “one embodiment,” “an embodiment,” or “embodiments” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

The above specification, examples and data provide a complete description of the manufacture and use of the invention. Since many embodiments of the invention can be made without departing from the spirit and scope of the invention, the invention resides in the claims hereinafter appended.

We claim:

1. A method of administering a single premium immediate annuity, the method comprising:
specifying a first income payment for a first payment term, wherein the first income payment represents an income payment purchasing power;
disbursing the first income payment;
determining an adjustment to the first income payment, wherein said adjustment to said first income payment may never be downward and each subsequent adjustment may never be downward in relation to the previous adjustment; and
applying the adjustment to the first income payment so that a second income payment for a second payment term has a purchasing power substantially equivalent to that of the first income payment.

2. The method of claim 1 further comprising:
specifying a maximum adjustment;
comparing the adjustment with the maximum adjustment and setting the adjustment equal to the maximum adjustment when the adjustment exceeds the maximum adjustment

3. The method of claim 1, further comprising:
determining if the adjustment is less than zero; and
when the adjustment is less than zero, setting the adjustment equal to zero.

4. The method of claim 1 wherein the adjustment is equal to an inflation rate.

5. The method of claim 1 wherein the adjustment is calculated using a Consumer Price Index.

6. The method of claim 5 wherein the Consumer Price Index is any consumer price index reported by the U.S. Bureau of Labor Statistics.

7. The method of claim 1 wherein the adjustment is calculated by:
$$Adjustment = ( \frac{{CPI}_{t}}{{CPI}_{t - 1}} - 1 ) 100 \%$$
where:
CPI=a consumer price index;
t=current time period; and
t−1=previous time period.

8. The method of claim 1, wherein the second income payment is calculated by:
$$Second Income Payment = ( First Income Payment ) ( \frac{{CPI}_{t}}{{CPI}_{t - 1}} )$$
where:
CPI=a consumer price index;
t=current time period; and
t−1=previous time period.

9. The method of claim 1 wherein the second payment term begins on a first day of a calendar year following the first payment term.

10. A method of administering a single premium immediate annuity, the method comprising:
recording a first economic indicator;
providing at least one first income payment for a first predetermined time;
recording a second economic indicator;
calculating a payment adjustment based upon the first economic indicator and the second economic indicator; and
calculating at least one second income payment for a second predetermined time, wherein the second income payment is adjusted by the payment adjustment.

11. The method of claim 10 further comprising:
specifying a payment adjustment cap;
determining if the payment adjustment is greater than the payment adjustment cap; and
if the payment adjustment is greater than the payment adjustment cap, setting the payment adjustment equal to the payment adjustment cap.

12. The method of claim 10, further comprising:
determining if the payment adjustment is less than zero; and
when the payment adjustment is less than zero, setting the payment adjustment equal to zero.

13. The method of claim 10 wherein the payment adjustment is equal to an average inflation rate since inception of the single premium immediate annuity.

14. The method of claim 10 wherein the payment adjustment is calculated using a first Consumer Price Index value and a second Consumer Price Index value, wherein the second Consumer Price Index value is the Consumer Price Index value for the year in which the adjustment is calculated.

15. The method of claim 10 wherein the payment adjustment is calculated using a first Consumer Price Index value and a second Consumer Price Index value wherein the second Consumer Price Index is the Consumer Price Index for the year in which the payment adjustment is calculated.

16. The method of claim 10 wherein the payment adjustment is calculated by:
$$Payment Adjustment = ( \frac{{CPI}_{t}}{{CPI}_{t - 1}} - 1 ) 100 \%$$
where:
CPI=a consumer price index;
t=current time period; and
t−1=previous time period.

17. The method of claim 10, wherein the second income payment is calculated by:
$$Second Income Payment = ( First Income Paymet ) ( \frac{{CPI}_{t}}{{CPI}_{t - 1}} )$$
where:
CPI=a consumer price index;
t=current time period; and
t−1=previous time period.

18. The method of claim 10 wherein the second predetermined time begins on a first day of calendar year following the first payment term.

19. The method of claim 10 wherein the first economic indicator comprises a first consumer price index and the second economic indicator comprises a second consumer price index.

20. A method of administering a single premium immediate annuity, the method comprising:
selecting an annuity type from either a first annuity type having a specified purchasing power and a second annuity type having a fixed percentage increase in an income payment;
specifying the first income payment for a first payment term;
disbursing the first income payment;
if the second annuity type is selected, increasing the first income payment by the fixed percentage increase; and
if the first annuity type is selected;
determining an adjustment to the first income payment, wherein the adjustment maintains the specified purchasing power; and
applying the adjustment to the first income payment so that a second income payment for a second payment term has the same purchasing power as the first income payment.
